(19) United States
(12) Patent Application Publication
(10) Pub. No.: US 2003/0009419 A1
(43) Pub. Date: Jan. 9, 2003

(54) Risk management system and trade engine with automatic trade feed and market data feed

(76) Inventors: R. Martin Chavez, New York, NY (US); Willis Boyce, New York, NY (US)

Correspondence Address: Peter J. Davis, Morrison & Foerster LLP, Suite300, 1650 Tysons Blvd., McLean, VA, 22102, US

(21) Appl. No.: 10/162,705

(22) Filed: Jun. 6, 2002

Related U.S. Application Data
(60) Provisional application No. 60/296,756, filed on Jun. 11, 2001.

(51) Int. Cl. G06F 17/60

(52) U.S. Cl. 705/38; 705/37

(57) ABSTRACT

The present invention relates to a system for processing trade data and market data to produce risk management reports and delivering reports, simultaneously, to multiple related and unrelated users over a distributed network. In one aspect of the invention, the risk management analysis includes the assessment of risk through mark-to-market, profit and loss, “greek”, FAS 133, and related reports. Further, market and trade data may be collected electronically from exchanges, information service provides, and other sources to be aggregated for use in the risk management analysis.

### BACKGROUND OF THE INVENTION

1. Field of the Invention

This invention relates to systems and methods for managing risk associated with transactions (traded online or not), for executing trades using a transaction system and for automatically providing delayed or live trade data and market data feeds between a transaction system and a risk management system.

2. Description of the Related Art

Risk management is the process of identifying, monitoring, and controlling external factors that can harm the performance of a business. Those external factors include: operational risk, such as a server crash, a misdirected wire transfer, or a fire in a warehouse; market price exposure or “price risk”, such as the price of oil or the level of interest rates; and credit exposure, such as the default of a counterpart to a derivatives transaction. Companies seek to mitigate those risks as effectively as possible to concentrate on the core businesses that drive the companies' earnings.

Two common tools companies use to manage risk are insurance and derivatives. Insurance mitigates operational risk, such as fire or earthquake damage. Derivatives mitigate, or “hedge,” ongoing price risk or credit exposures. To manage price risk properly, a company must identify and measure the market factors that affect its business and determine the level of risk tolerance that it is willing to bear. Unwanted and diversifiable risks should be offloaded, using risk-transfer products to a party that has the opposite exposure. Derivatives dealers typically intermediate the transfer of risk, buying risk transfer instruments from companies having one risk exposure and selling them to companies having the opposite exposure. However, oppositely situated institutions are beginning to trade with one another directly; for instance, a large oil producer might sell call options directly to an airline. That is, a large oil producer owns oil and is a net seller of oil products, whereas an airline is a net buyer of oil products. Thus, they have opposite market exposures, and can manage their exposure to price risk by trading with each other. For example, the oil producer, guarding against a possible decrease in the price of oil, might want to sell an option to buy oil in the future at a certain price. The airline, on the other hand, concerned that the price of oil might rise in the future, might be willing to purchase an option to buy oil in the future at that price.

The commodities, fixed-income and other markets provide an arena for the trading of derivatives—any instrument that derives its value from another asset, event or benchmark. A derivatives user is often concerned with the sensitivity of the price of a derivative to changes in underlying market variables. The family of sensitivities to various market factors are collectively known as “the greeks,” since many are named after Greek letters (e.g. delta, gamma, vega, theta, rho). For example, delta measures the change in derivative value for a given change in the underlying price(s).

A trader typically tries to match the delta of a hedge to the delta of an underlying risk. In this way, the loss on the hedged item is offset by a gain on the derivative (and vice versa). The greeks are important for portfolios of trades as well as for individual instruments. A trader wants to know how a change in a market variable affects his portfolio as a whole.

Since market conditions, and hence price risk and credit exposure, are constantly changing, risk management does not stop with a one-time transaction—it must be a dynamic process. Therefore, companies must constantly monitor their underlying risks and adjust their risk management strategies accordingly.

A number of risk management tools and reports have been developed to assist participants in the derivatives market. For example, pricing and hedging calculators allow users to measure the fair value of a derivative instrument, given various market parameters and trading levels, and to calculate greek reports. These tools are critical both to ensure a fair exchange of risk for new transactions and to measure how effectively an existing position offsets an underlying exposure.

In addition to reports that list current prices, risk, and profit and loss (PNL), derivatives traders (dealers as well as companies seeking to mitigate risk) often rely on forward-looking reports to assess the future possible performance of various portfolios. Two such reports are “Value at Risk (VAR) reports and “stress tests.” VAR reports attempt to examine all possible future market movements, calculating a maximum loss on the portfolio with a given probability or “confidence level” over a specified period of time. For example, a VAR report might indicate that a company can be 95% certain that it will not lose more than $5 million on its positions over the next two weeks. VAR can be run using either historical or “Monte Carlo” simulations. Historical VAR uses actual price histories to calculate the size of the potential loss of the portfolio. Monte Carlo simulations use probabilities and correlations implied by option prices (or in some cases by histories) in the current market to estimate probability distributions, which can then be used to calculate the size of the potential loss of the portfolio.

Stress tests are similar to VAR in that they test a portfolio's performance under hypothetical market movements, but run specific scenarios defined by the user. For example, a company could stress test its portfolio by simulating the market's movements during the 1998 Russian debt default, the energy supply shock caused by the Gulf War or the events associated with the California energy crisis in 2001. As event risks that produce major losses are more common than lognormal distributions imply, stress testing is necessary to identify exposures not captured by those standard modes.

In the prior art, each trader typically maintained his or her own spreadsheet of trades, supplemented with a variety of risk management calculation software. When a trader made a transaction, the trader manually entered it into his spreadsheet. The trader also typically input market data into the spreadsheet manually. When the trader wished to evaluate the potential risk of a specific trade, he needed to enter the spreadsheet, highlight the trades he wanted to evaluate and call up a separate application to run the risk calculations.

Using the prior art spreadsheet-based risk management system, no supervisor or risk manager can quickly or easily evaluate the position of any other person's trade or trades. Also, the prior art does not provide for the assessment of the combined risk across the positions of multiple traders without similarly manually entering all the trades into a single spreadsheet and running a separate risk analysis.

Without the proper analytical tools to price and measure the risks of derivatives transactions, participants face serious hazards, especially in the less transparent markets such as the commodities markets. Inefficiencies in trade execution make the current market opaque rather than transparent. Transparency is a simple, but elusive idea: it means that market “participants have intelligence about the markets around them . . . Aberrant behavior—artificially high prices or unusually low quality—gets isolated quickly and competitive alternatives eliminate the anomaly.” Morgan Stanley Dean Witter: Charles Phillips, Mary Meeker, “The B2B Internet Report—Collaborative Commerce,” April 2000.

When a technologically unsophisticated participant trades a complicated instrument with a dealer who enjoys state-of-the-art risk management systems, the dealer can use that advantage to charge an excessive bid-ask spread. For example, most market participants rely on an inefficient phone-brokered system to execute trades. These participants incur excessive search costs as they contact multiple dealers to execute a desired trade, if they bother at all. The dealers frequently do not represent the best bids or offers in the market, so that market participants often trade at a disadvantage. Worse, dealers can exploit their superior information flows by buying or selling in front of their customers, resulting in higher (if often hidden) costs. After trades have been executed, customers without good risk management are unable to monitor the total risk exposure in their portfolios, and career-ending surprises in the PNL report frequently result. Well-documented cases of derivatives blow-ups are all too common in the commodities markets.

Because most derivatives traders must navigate those dark alleys alone, without adequate technology to light their way, a distinct information and competitive advantage exists for large dealers at the expense of corporate users. As a consequence, corporate users are seldom able to employ derivatives wisely, effectively, and confidently without risk management solutions that guide them through market obscurities. The present invention penetrates a market's lack of transparency and avoids these results by accurately pricing both simple and complex derivatives, thus ensuring fair trade execution, and measuring a position's sensitivity to market price movements, time, and volatility changes, thus ensuring proper portfolio management.

### SUMMARY OF THE INVENTION

The invention described herein provides a solution to the inequities and disadvantages of the present trading and risk management systems by providing a risk management system that allows the market at large to gain access, for the first time, to sophisticated tools that explicate and manage the risks associated with commodities and other derivative instruments. The present invention also provides features and benefits not previously available even to sophisticated market participants. Specifically, the present invention provides for the first time the capability for one user to quickly and easily access and evaluate the risk of multiple trades across multiple related or unrelated users, or for many users to access and evaluate the risk of a single user's trades or portfolio(s). For example, a company might group its crude oil hedges into one book and its natural gas hedges into another. The company's risk officer can look at the performance of each book individually to evaluate the performance of each trader, or look at the two books combined to view the overall performance of the company's positions.

Furthermore, the invention for the first time provides a user with the ability to select between a variety of established and regularly maintained current and historical market databases against which to evaluate his trades, without the need for cumbersome manual data entry and maintenance.

According to a further aspect of the invention, there is provided a trade engine that provides an electronic marketplace where trade orders are executed fairly and efficiently, and where all market participants have access to the same market data and pricing tools. The trade engine according to the invention also may employ an “Inner and Outer” membership system that guarantees creditworthiness between trading parties.

While the risk management system of the present invention and the trade engine of the present invention may each be used separately, or matched or integrated with other different products, the risk management and trading technologies of the present invention, when used together, allow market participants to use derivatives even more wisely and effectively, at the same time creating unprecedented efficiency, fairness, liquidity, and transparency in the execution process. Specifically, the synergies created by using the risk management and trading technologies together arise from the trade data and market data feeds, which feed trade data (such as the price at which a particular trade was executed, the lot size and the parties to the trade) and market data (such as bid, ask, and settlement prices for certain commodities or derivatives, i.e., raw data) from the trade engine to the risk management system on a delayed or real-time basis.

Access to the risk management system of the invention is provided to users via subscription, transaction fee, or other paid basis, over the internet or a private network.

### DETAILED DESCRIPTION OF THE INVENTION

The risk management system of the present invention is a secure, flexible, and easy-to-implement Java-based software application that may be used as a standalone system or as a system that can be integrated with existing infrastructures, e.g., existing trading, portfolio-management and back-office systems, through an applications programming interface. According to a preferred embodiment of the invention, the risk management system resides on a server, or on multiple servers in communication with one-another, and user access to the risk management system is password-protected through Java-based thin clients running on the user's web browser. The user's browser may be any browser that resides on a user's PC, PDA, web-enabled cellular device, or the like, and may be connected to the invention through any distributed network, e.g., the Internet or a private network.

Once a user has accessed and logged into the system, he can request an array of position-keeping and risk assessment reports examining the user's portfolio. Navigating the browser page, the user may enter data for a recently executed trade, or select to run one or more reports on a single trade, a portfolio of trades, or multiple portfolios of trades. Additionally, the user can select from several market databases against which his position(s) may be assessed. The user can further customize his risk analysis by selecting any combination of risk calculations supported by the system.

The system is able to serve multiple related (users employed by or associated with a common organization) and unrelated users (users employed by or associated with different organizations) simultaneously, and can also report on trade data aggregated across related users, or unrelated users (e.g., to run risk reports across different organizations). The system may also be continuously expanded by adding more memory and/or processing power to accommodate ever more users.

All reports of the risk management system of the present invention can be run on archived market data, real-time feeds, user-defined data or a combination of these inputs. All inputs can then be adjusted in any direction, offering full flexibility for stress testing and scenario analysis. Market data required to run the risk management system of the present invention can be fed directly from users or third-party data sources (in the case of data that is passed through the risk management system without modification) or can represent processed data that is stored in the system and accessible by users.

Trade data may be entered manually, or imported electronically from existing legacy files and/or databases. Additionally, trades executed electronically (using the trade engine aspect of the invention or other electronic trading platform) may be fed directly to the risk management system of the invention, as well as to existing position management systems via the applications programming interface, allowing the seamless integration of new and legacy trades.

Turning to the operation of the invention, the risk management system of the present invention integrates trade data for the trade(s) of one or more users with raw and/or processed market data received from a variety of third-party sources, and produces risk reports therefrom. While trade data for users' trades may be entered manually or imported electronically from legacy systems, according to a preferred embodiment of the present invention, the risk management system of the invention receives all new trade data from an integrated trade engine, and receives market data both from the integrated trade engine and from a variety of third-party sources.

When a user first logs onto the system, he is prompted to enter the identifying information for his existing, or “legacy,” trades (trade data) into the system. This identifying information typically includes the type of instrument, the parties to the instrument, and the date and the price of the instrument. As the user enters the trades into the system, he will be given the option to group the trades by book and/or by portfolio. This option is available to users at any time. As an alternative to manual entry of trade data, the system may prompt the user to identify a computer file, for example, the user's previous risk management electronic spreadsheet, from which the user's trade data may be imported electronically. According to a preferred embodiment of the invention, all of a user's existing trades are loaded into the system when the user first uses the system. As the trades are loaded into the system, they are each associated with the user's I.D. and password so that they can be readily accessed by the user each time he logs onto the system. Additionally, the user is prompted to identify any electronic files or other applications, such as trade engines, that the invention should query periodically for new trades transacted by the user. In this fashion, as the user conducts additional trades, these new trades are automatically loaded into the system.

According to the embodiment of the invention where the risk management system is integrated with the trade engine of the invention, trades generated in the trade engine can be fed directly to the risk management system. According to this embodiment, when the trade engine generates a trade, it checks to see whether either party to the trade subscribes to the risk management system, and if so, whether the user has configured the system to receive data for new trades directly from the trade engine.

The risk management system of the present invention may also receive trades directly from external trade engines. Indeed, any trading system can serve as a source for trades to populate the risk management system of the present invention, provided that the trading system's requests are in a format, or can be converted into a format, that can interface with the risk management system.

In order to evaluate the risk of each user's trade, book of trades, or portfolio, the system must be populated with market data relevant to each trade resident in the system. According to the invention, the system electronically retrieves the closing prices for all of the types of instruments that users have loaded into the system from various public and private sources. In addition, the system contains historical market data [back to 1900, and has the capability to store even additional historical data further in the past]. In addition to closing prices, the system also retrieves forward curves (predictions of future prices over time) from third-party sources and creates forward curves by applying its own algorithms and processes.

The risk management system of the present invention can have some or all the following features:

1. Multifactor models with mean reversion, seasonality and volatility skew, supporting the correct pricing of early-dated options on long-dated contracts.

2. Real-time pricing tools supporting exotic instruments and complicated derivative structures.

3. Real-time calculation of all risk reports using: (a) live positions; (b) up-to-the-second trade data; (c) raw and processed market data; and (d) live traders' marks.

4. Comprehensive trading and risk management reports allowing the spontaneous aggregation of books and portfolios, and supporting drill-down to groups of trades (by trade type), individual trades, and the component coupons of trades, in particular:

a “Delta Report,” which shows volatility-adjusted portfolio deltas by commodity (part of the Greek report);

a “Detailed PNL Breakdown Report,” which breaks the daily PNL into contributions based on multiple components including new trades, prior-day amendments, futures prices, forward prices, time evolution, volatilities, correlations, foreign exchange, and interest rate;

a “Top Sheet,” which gives deltas and gammas at various market levels, volatility curves, and interest rate levels;

a “Vega Report,” which gives volatility risk for various time periods (part of the Greek report);

a “Theta Report,” which gives daily time decay for each trade;

a “Mark-to Market report,” which gives the up-to-the-second price of each position in a book;

a “Strike Report,” which details the concentration of positions at different strikes;

a “Value at Risk Report,” which provides individual trade and multiple portfolio breakdown options for calculating the maximum. potential exposure over a given time horizon with a given probability;

an “Expected Transaction Report,” which provides a list of positions with imminent expected transactions, such as options expirations, etc.; and

a “Cash Flows” and “Earnings at Risk” Report, which provide the maximum potential cash flow and maximum earnings loss, respectively, over a given time horizon with a given probability.

The risk management system of the present invention may also provide reports that enable compliance with accounting regulations such as the Financial Accounting Standards Board's (FASB) Statement 133, including: reports that allow grouping, matching, and real-time tracking of obligations and hedges in one-to-one, one-to-many, many-to-one, and many-to-many relationships; and pre- and post-trade hedge effectiveness evaluation.

As mentioned above, the invention also provides certain users the capability to request risk reports for trades, books of trades, and/or portfolios of other users. According to this embodiment of the invention, the system is configured so that each user has a set of access rights. In typical use, most users will have rights to access and request risk analysis reports for those trades entered by that user or upon that user's authorization. However, certain users, for example, supervisors and risk managers, may be given rights by a system administrator to access and request risk analysis reports for the trades, books of trades, and/or portfolios of multiple users. In addition, such authorized users may group the trades of one or more other users into separate management portfolios to facilitate quick and simple running of reports on a regular basis. However, the grouping of trades into management portfolios by authorized supervisory users does not affect portfolio groupings established by the users who entered the trades into the system.

According to a preferred embodiment of the invention, the system includes a business objects processing module which serves as an organization engine. According to this embodiment, each user, each group of users, each instrument, each book and each portfolio is represented by an object. Instrument objects represent the parameters of a particular trade, or deal made by a user, and may be version controlled (i.e., instruments cannot be changed—changes are stored as new versions of the instrument, without overwriting or deleting the previous version) to permit auditing and the inclusion or exclusion of the instrument from the report generation process. Book objects represent a collection of instruments, and portfolio objects represent an organization and a grouping of instruments or books. Books may be contained in more than one portfolio, and portfolios may contain other portfolios. This aspect of the organization engine facilitates the production of risk analyses based on trade data for more than a single user—manipulations of the grouping of instruments enable risk analyses to be performed on all or various portfolios of multiple users.

Another feature of the business objects processing module is a group of directories that act as repositories for market data. One directory may contain historical prices obtained from third-party market data sources. Another directory may contain processed market data.

The business objects processing module may also contain databases for currency exchange rates, holiday calendars with information indicating when exchanges are closed for trading, unit of measure conversions and rules, market commodity data such as ticker symbols and contract dates, and exchange information with listed contract details. Such databases of general information are categorized as shared entities, as the data stored therein can be accessed by the system for use in risk calculations, and/or sent directly to users as part of reports, as part of the user interface, or in response to user requests.

Market data sources are objects representing a set of rules that an organization will define as to how such market data is to be gathered for pricing purposes. Other objects in this portion of the system represent broker information, counterpart identity, commodity subscriptions which provide an organization-specific view of the shared commodity information, as well as curve length and access control to shared market data. Further objects represent organization/user marks, acting as a specific market data repository, and a report object representing a request for a report or the resulting report document.

According to a further embodiment of the invention, there is provided a trade engine for managing the execution of trades of financial instruments between traders. The trade engine aspect of the present invention is specifically designed to enable the fair and efficient trading of commodity and other derivatives to create a liquid and transparent centralized marketplace. It can be integrated with the risk management system of the present invention, providing the risk management system with an automatic and seamless trade data capture capability, or deployed as a stand-alone order matching system. According to a most preferred embodiment of the invention, the risk management system and the trade engine of the present invention are both web-based, and are integrated or otherwise matched to one-another to allow straight-through processing of trade data and/or market data from the trade engine to the risk management system on either a delayed or real-time basis, without manual intervention.

The trade engine of the present invention enables traders to do the following:

enter orders for standard and exotic commodity-derivative products;

submit various kinds of orders, including market, limit, and stop orders;

place restrictions on orders (for instance, minimum execution size, “good-till-cancelled,” “one-cancels-other,” and “fill-or-kill”);

receive executions and confirmations;

enter and request non-binding quotes; and

respond to requests for quotes entered by other traders.

Another feature of the trade engine of the present invention is its treatment of credit issues and its ability to accommodate a variety of credit management strategies. The system can be based on an “Inner and Outer” member model. Inner members establish and manage credit lines with each other using a credit matrix. Outer members can trade directly on the trade engine with the consent of one or more Inner members. The trade engine monitors the process using embedded risk management technology and makes credit checks before matching any trades. The trade engine accordingly supports a wide variety of market structures, and facilitates any transition between bilateral and multilateral credit risk mitigation models.

The foregoing description is intended to be an illustrative and non-limiting example of the invention. Persons of ordinary skill in the art will recognize that the invention may be implemented with any number of variations from the foregoing description and still fall within the scope of the claims below, the terms of which are intended by the inventors to be construed according to their broadest ordinary meanings.

We claim:

1. A method for providing risk management services simultaneously to a plurality of users, comprising:
electronically storing market data for a plurality of financial instruments;
electronically storing trade data for a plurality of financial instrument transactions; executed by a plurality of users;
electronically receiving requests over a distributed network from a plurality of users for risk reports on one or more of said financial instrument transactions;
using at least some of said market data to perform simultaneous risk calculations for said requested risk reports;
simultaneously producing risk reports for said plurality of users; and
electronically transmitting said risk reports over said distributed network.

2. The method according to claim 1 wherein the market data is electronically received from a third party.

3. The method according to claim 2 wherein at least some of said market data is processed prior to said storing step.

4. The method according to claim 2 wherein at least some of said received market data is stored without any processing.

5. The method of claim 1 wherein at least some of said trade data is electronically received from a trade engine.

6. The method of claim 1 wherein said trade data is electronically received from a plurality of trade engines.

7. The method of claim 1 wherein said plurality of users are employed by the same entity.

8. The method of claim 1 wherein said plurality of users are employed by more than one entity.

9. The method of claim 1 further comprising storing access rights for each of said plurality of users.

10. The method of claim 9 further comprising granting or refusing a first user's access to trade data for transactions executed by a second user based on said stored access rights.
